(19) United States
(12) Patent Application Publication
(10) Pub. No.: US 2016/0258834 A1
(43) Pub. Date: Sep. 8, 2016

(54) SYNCHRONIZATION-FREE PIPELINE LEAK DETECTION SYSTEM AND METHOD

(71) Applicant: KING FAHD UNIVERSITY OF PETROLEUM AND MINERALS, Dhahran (SA)

(72) Inventors: ANAS AL-ROUBAIEY, DHAHRAN (SA); UTHMAN BAROUDI, DHAHRAN (SA)

(21) Appl. No.: 14/639,088

(22) Filed: Mar. 4, 2015

(51) Int. Cl. G01M 3/24

(52) U.S. Cl. CPC G01M 3/243

(57) ABSTRACT

The synchronization-free pipeline leak detection system includes a plurality of acoustic sensor nodes positioned equidistantly and linearly against an external surface of a wall of a pipeline. Each of the acoustic sensor nodes receives an acoustic signal generated by a leak in the wall of the pipeline, which is transmitted through fluid flowing through the pipeline. Each of the acoustic sensor nodes measures an acoustic received signal strength associated with the acoustic signal and transmits a signal representative of the respective acoustic received signal strength to the immediately adjacent acoustic sensor nodes if the respective acoustic received signal strength is greater than a threshold signal strength value. From the transmitted acoustic received signal strengths between sensor nodes, the sensor node closest to the leak can be determined. From known values stored in each sensor node, the position of the leak can be calculated and transmitted in an alert signal.

### BACKGROUND OF THE INVENTION

1. Field of the Invention

The present invention relates to pipeline monitoring, and particularly to an synchronization-free pipeline leak detection system and method for monitoring pipelines for fluid leaks that requires no synchronization between the acoustic sensors.

2. Description of the Related Art

Leaks in pipelines carrying water, oil, gas and the like are both common and of great concern. Such leaks may have serious economic and ecological consequences. Numerous systems for both detecting and localizing leakages in long-distance pipelines have been proposed. Most of these approaches, however, require human intervention and, in some cases, require the entire pipeline to be shut down. Although a network of automated sensors could alleviate these problems, such networks are difficult to implement.

Present techniques using networked sensors commonly take advantage of acoustic techniques, involving microphones placed about the pipeline to pick up acoustic signals generated by leaking fluids. Signal processing techniques are then applied to determine the distance of the leak from each of two measuring points. Other techniques depend on generating specific ultrasonic signals and then studying their behavior under normal operating conditions, as well as under leakage conditions.

These methods, however, depend on the assumption of perfect time synchronization among the microphones involved in the detection/localization process. This stringent requirement is either accomplished via special algorithms or via global positioning system (GPS) devices, both of which are not only costly, but require relatively large energy consumption. Particularly when applied to a long-distance pipeline, neither is practical for implementing a continuous monitoring system.

Thus, a synchronization-free pipeline leak detection system and method addressing the aforementioned problems is desired.

### SUMMARY OF THE INVENTION

The synchronization-free pipeline leak detection system includes a plurality of acoustic sensor nodes positioned equidistantly and linearly against an external surface of the wall of a pipeline. Each of the acoustic sensor nodes receives an acoustic signal generated by a leak in the wall of the pipeline, which is transmitted through fluid flowing through the pipeline. Each of the acoustic sensor nodes measures an acoustic received signal strength associated with the acoustic signal and records the time of reception of the acoustic signal in non-transitory, computer readable memory associated with the acoustic sensor node. Each acoustic sensor node compares the respective acoustic received signal strength against a threshold signal strength value and transmits a signal representative of the respective acoustic received signal strength to adjacent ones of the plurality of acoustic sensor nodes if the respective acoustic received signal strength is greater than the threshold signal strength value.

Each of the acoustic sensor nodes then compares the acoustic received signal strengths transmitted by the adjacent acoustic sensor nodes against the acoustic received signal strength measured by itself, and records respective times of reception of each of the acoustic received signal strengths measured by the adjacent acoustic sensor nodes in the non-transitory, computer readable memory associated with the acoustic sensor node. The acoustic sensor node closest to the leak is then determined to be the acoustic sensor node with an acoustic received signal strength measured thereby that is greater than the acoustic received signal strengths transmitted by the two adjacent acoustic sensor nodes. An acoustic sensor node second closest to the leak is determined to be the adjacent acoustic sensor node that has the greater measured acoustic received signal strength.

The distance, L, from the leak to the acoustic sensor node closest to the leak (the leak is positioned between the acoustic sensor node closest to the leak and the acoustic sensor node second closest to the leak) may then be calculated as:

L=[D−V·(TACK2−t1)]/2,

where D represents a distance between adjacent acoustic sensor nodes, V represents the speed of acoustic signal transmission in the fluid, TACK2 is the recorded time of reception at the acoustic sensor node closest to the leak of the acoustic received signal strength measured by the acoustic sensor node second closest to the leak, and t1 represents the recorded time of reception of the acoustic signal from the leak that is received by the acoustic sensor node closest to the leak. An alert signal representative of a position of the leak in the wall of the pipeline may then be transmitted.

These and other features of the present invention will become readily apparent upon further review of the following specification.

### BRIEF DESCRIPTION OF THE DRAWINGS

FIG. 1 is a schematic diagram showing a pipeline equipped with a synchronization-free pipeline leak detection system according to the present invention.

FIG. 2 is a block diagram illustrating system components of a sensor node of the synchronization-free pipeline leak detection system of FIG. 1.

Similar reference characters denote corresponding features consistently throughout the attached drawings.

### DETAILED DESCRIPTION OF THE PREFERRED EMBODIMENTS

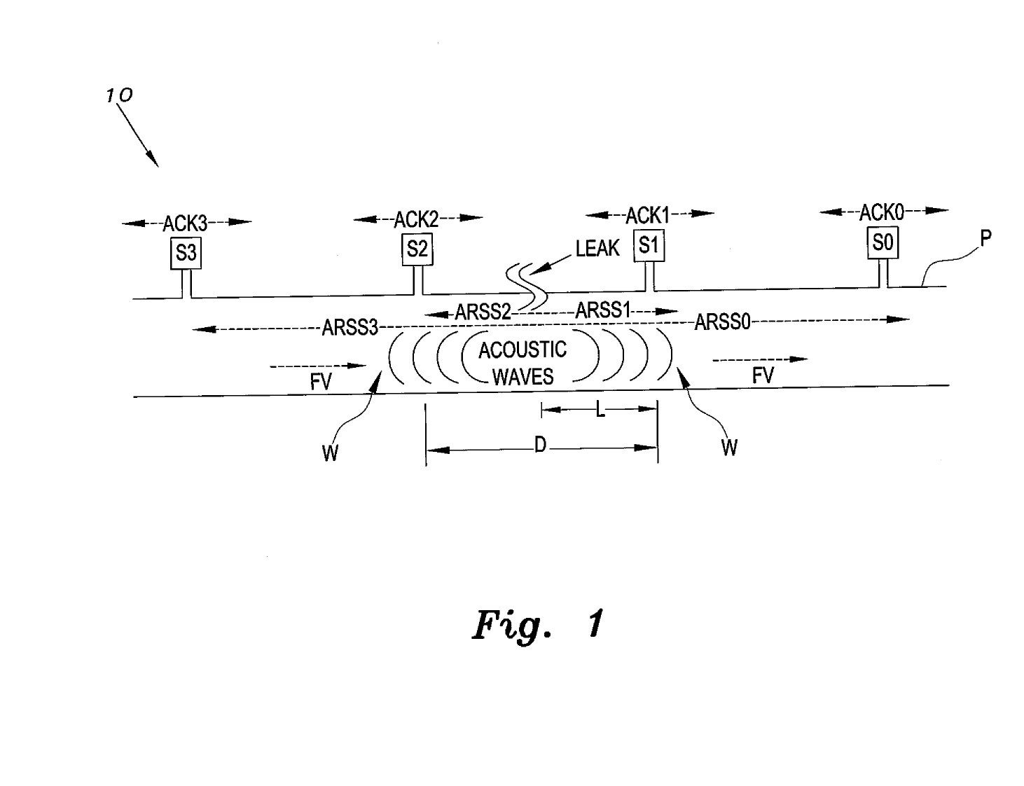

As shown in FIG. 1, the synchronization-free pipeline leak detection system 10 includes a plurality of acoustic sensor nodes S0, S1, S2, S3 fixed to an external surface of pipeline P. Although only four such sensors nodes are shown in FIG. 1, it should be understood that this is for illustrative purposes only, and that the sensor nodes, spaced apart from one another by a distance D, are provided in sufficient number to span at least a portion of interest of pipeline P. It should be understood that any suitable type of acoustic sensors or acoustic sensor nodes may be utilized.

A leak in the wall of pipeline P will generate an acoustic signal (shown in FIG. 1 as exemplary acoustic waves W) in the fluid flowing through pipeline P (e.g., gas, oil, water, etc.). The direction of the fluid flow velocity FV is shown by the arrows in FIG. 1. The acoustic signal propagates both downstream and upstream, originating from the location of the leak, and is detected by sensor nodes S0, S1, S2, S3 (in the exemplary arrangement shown in FIG. 1), In FIG. 1, the acoustic received signal strength (ARSS) received at each of sensor nodes S0, S1, S2 and 53 is indicated as ARSS0, ARSS1, ARSS2 and ARSS3, respectively. Each of sensor nodes S0, S1, S2 and S3 is equipped with a transceiver for generating an acknowledgment signal (ACK0, ACK1, ACK2 and ACK3, respectively) to be exchanged between neighboring sensor nodes when one of the sensor nodes detects an ARSS greater than a predetermined threshold strength. As will be explained in greater detail below, this allows the system 10 to provide leak detection without the need for global synchronization among the sensor nodes. As will be explained in greater detail below, the system 10 operates in two main steps. First, the closest sensor node to a leak is determined, along with determining the leak direction with respect to that closest sensor node (i.e., to the right or left of that closest sensor node). Second, the precise location of the leak is determined.

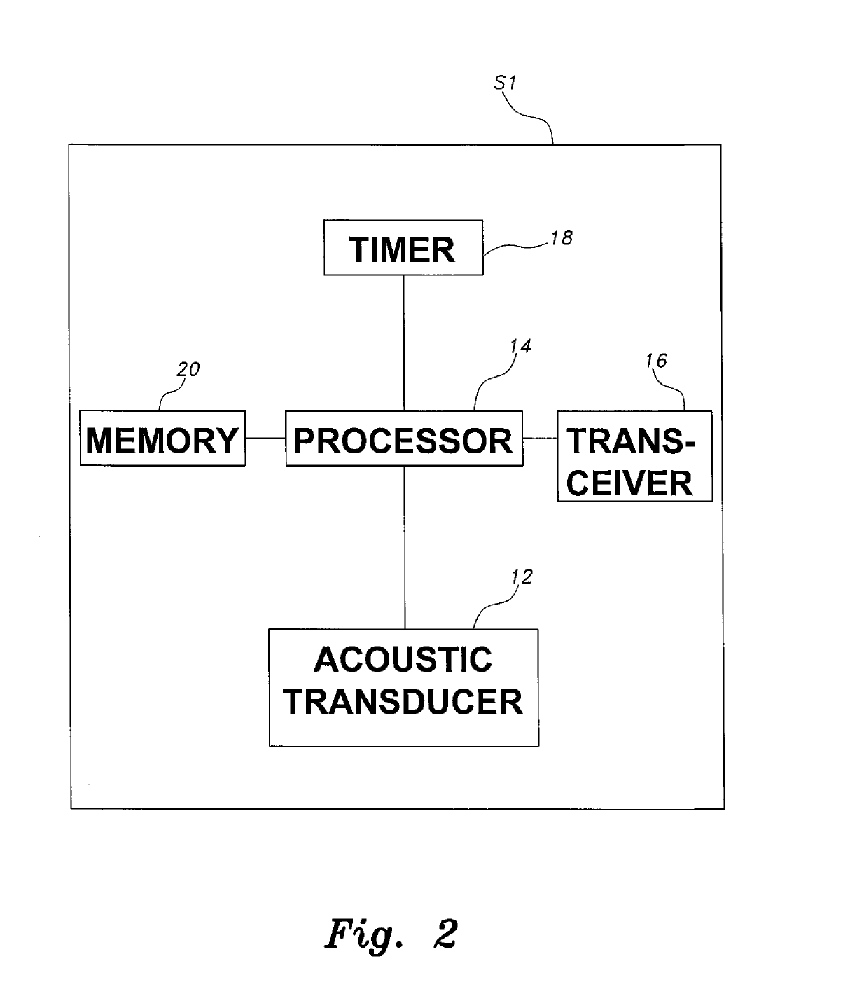

FIG. 2 diagrammatically illustrates sensor node S1. It should be understood that each of the sensor nodes of system 10 is identical. As shown in FIG. 2, each of the sensor nodes includes an acoustic transducer 12, a processor or controller 14, associated memory 20 and a transceiver 16. As will be described in detail below, each sensor node relies on the time of reception of the acoustic signal, and timing signals may be generated by the processor or controller 14, or by a separate timer or timing circuit 18. Any suitable type of acoustic transducer 12 may be used for picking up the acoustic signals and determining the acoustic received signal strength, as is well known in the art. The acoustic transducer 12 is in communication with processor or controller 14, which determines whether the measured ARSS value is greater than the predetermined threshold. The processor 14 controls transmission of the respective acknowledgment signal containing the ARSS by transceiver 16. Although wireless transmission is preferred, it should be understood that any suitable type of wireless or wired transceiver may be utilized for transmitting the acknowledgment signals, as is well known in the art.

Data, such as the measured ARSS, the time of reception of the acoustic signal, and the predetermined threshold strength, may be stored in memory 20, which can be any suitable type of computer readable and programmable memory, and is preferably a non-transitory, computer readable storage medium. Calculations are performed by processor 14, which can be any suitable type of computer processor. The processor 14 can be associated with, or incorporated into, any suitable type of computing device, for example, a personal computer, a programmable logic controller (PLC), or an application specific integrated circuit (ASIC). The processor 14, the memory 20, transceiver 16, acoustic transducer 12 and timer 18, along with any other associated computer readable recording media, are in communication with one another by any suitable type of data bus, as is well known in the art.

Examples of computer-readable recording media include non-transitory storage media, a magnetic recording apparatus, an optical disk, a magneto-optical disk, and/or a semiconductor memory (for example, RAM, ROM, etc.). Examples of magnetic recording apparatus that can be used in addition to memory 20, or in place of memory 20, include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. It should be understood that non-transitory computer-readable storage media include all computer-readable media, with the sole exception being a transitory, propagating signal.

In operation, each of acoustic sensor nodes S0, S1, S2 and S3 receives an acoustic signal generated by the leak. The acoustic received signal strength measured by each sensor node is denoted as ARSS0, ARSS1, ARSS2 and ARSS3, respectively. If the acoustic received signal strength measured by one of the sensor nodes is greater than a predetermined threshold strength, then the sensor node transmits an acknowledgment signal to its neighboring sensor nodes with the measured ARSS. For example, if sensor nodes S1 and S2 each measure an ARSS greater than the predetermined threshold, then sensor node S1 transmits the acknowledgment signal ACK1 to sensor nodes S2 and S0. The acknowledgment signal ACK1 contains data representative of the measured ARSS1. Similarly, sensor node S2 transmits the acknowledgment signal ACK2 to sensor nodes S3 and S1, the acknowledgment signal ACK2 containing data representative of measured ARSS2.

Each sensor node compares its own measured ARSS with its neighbors' ARSS values. The sensor node with the ARSS that is greater than both of its neighbors' ARSS values is determined to be the sensor node that is closest to the leak. In the example given above, for purposes of simplification, sensor S0 did not have a measured ARSS greater than the pre-determined threshold. Thus, sensor node S1 would view ARSS0 as zero. Whether the value is determined to be zero or whether ARSS0 is simply less than ARSS1, and if ARSS2 is also less than ARSS1, then acoustic sensor node S1 is determined to be the closest sensor node to the leak. Once sensor node S1 has been determined to be the nearest sensor node to the leak, the direction of the leak (to the left or the right of sensor node S1) is determined by comparing the ARSS values of sensor node S1's neighbors; i.e., if ARSS2 is greater than ARSS0, then the leak is between sensor node S1 and sensor node S2 (to the left of sensor node S1 in the exemplary configuration of FIG. 1), and if ARSS0 is greater than ARSS2, then the leak is between sensor node S1 and sensor node S0 (to the right of sensor S1 in FIG. 1). In FIG. 1, the leak is shown as being to the left of sensor node S1. Thus, ARSS2 is greater than ARSS0.

In the example given above, where sensor node S1 is determined to be the sensor node closest to the leak, and the leak has been determined to be to the left of sensor node S1, the time t1 when sensor node S1 received the acoustic signal (associated with measured ARSS1) was recorded in memory 20. As noted above, the timer or timing circuit 18 for generating time signals may be separate from the processor 14 or integrated into the processor 14. Additionally, the time TACK2, when sensor node S1 received ACK2 from sensor node S2, and the time TACK0, when sensor node Si received ACK0 (if any) from sensor node S0, are also recorded in memory 20. Additionally, the known values of distance D (representing the distance between adjacent sensor nodes) and the signal velocity V in the fluid (i.e., the speed of sound for the particular fluid at its particular temperature and pressure, as modified by the fluid velocity FV, depending upon whether the signal is being transmitted upstream or downstream from the leak to the sensor S1) are stored in memory 20.

The processor 14 may then calculate the distance between sensor node S1 and the leak, L, as:

L=[D−V·(TACK2−t1)]/2.

It should be noted that each of the times TACK2 and ti is recorded in the memory associated with sensor node S1 alone, thus the distance L is calculated only from timestamps recorded by the single sensor node S1, removing the necessity for global sensor synchronization. The foregoing assumes that the ACK2 signal is transmitted immediately upon sensing the acoustic wave from the leak. Once the position of the leak has been detected, an alert signal containing the position information may be transmitted, by transceiver 16, to a user or an external base station for repair and maintenance. As noted above, although only four such sensors S0, S1, S2 and S3 are shown in FIG. 1, it should be understood that any desired number of sensors may be utilized, and that the four sensors are shown for purposes of simplification only. Further, it should be understood that the synchronization-free pipeline leak detection system 10 may be used in any situation where the propagation delay through the medium (gas, oil, other fluid in a pipeline, etc.) of the signal generated by a leak (or any other source) is much greater than the propagation delay caused by external signal transmission (i.e., signal generation via the wireless or wired transceivers).

It is to be understood that the present invention is not limited to the embodiments described above, but encompasses any and all embodiments within the scope of the following claims.

We claim:

1. A synchronization-free pipeline leak detection system, comprising a plurality of acoustic sensor nodes positioned equidistantly in a linear array against an external surface of a wall of a pipeline, each of the acoustic sensor nodes having:
an acoustic transducer for receiving an acoustic signal generated by a leak in the wall of the pipeline and transmitted through fluid flowing through the pipeline, and for further measuring an acoustic received signal strength associated with the acoustic signal;
a transceiver for generating and transmitting acoustic signal strengths sensed by the transducer and receiving acknowledgement signals of acoustic received signal strengths sensed by its immediately adjacent sensor nodes;
non-transitory, computer readable memory;
means for recording the time of reception of the acoustic signal from the leak in the non-transitory, computer readable memory;
means for comparing the acoustic received signal strength against a threshold signal strength value, the transceiver transmitting a signal representative of the acoustic received signal strength to the immediately adjacent acoustic sensor nodes when the acoustic received signal strength is greater than the threshold signal strength value;
means for comparing the acoustic received signal strengths in the acknowledgement signals transmitted by the immediately adjacent acoustic sensor nodes against the acoustic received signal strength of the acoustic signal from the leak measured by the transducer;
means for recording respective times of reception of each of the acknowledgement signals from the immediately adjacent acoustic sensor nodes in the non-transitory, computer readable memory;
means for determining an acoustic sensor node closest to the leak to be the acoustic sensor node having the greatest measured acoustic received signal strength;
means for determining an acoustic sensor node second closest to the leak to be the immediately adjacent acoustic sensor node measuring the second greatest acoustic received signal strength; and
means for calculating a distance from the leak to the acoustic sensor node closest to the leak as:
L=1/2[D−V·(TACK2−t1)],
where D represents a distance between each adjacent pair of the acoustic sensor nodes, V represents a speed of acoustic signal transmission in the fluid, TACK2 is the recorded time of reception at the acoustic sensor node closest to the leak of acknowledgement strength of the acoustic sensor node second closest to the leak, and t1 represents the recorded time of reception of the acoustic signal from the leak at the acoustic sensor node closest to the leak, the transceiver transmitting an alert signal representative of a position of the leak in the wall of the pipeline.

2. A synchronization-free pipeline leak detection method, comprising the steps of:
providing a plurality of acoustic sensor nodes positioned linearly and equidistantly against an external surface of a wall of a pipeline;
receiving an acoustic signal generated by a leak in the wall of the pipeline and being transmitted through fluid flowing through the pipeline, the receiving being by at least one of the acoustic sensor nodes;
at each of the acoustic sensor nodes receiving the acoustic signal, measuring an acoustic received signal strength associated with the acoustic signal and recording a time of reception of the acoustic signal in non-transitory, computer readable memory associated with the acoustic sensor node;
comparing the respective acoustic received signal strength against a threshold signal strength value, the comparing being performed by each of the acoustic sensor nodes receiving the acoustic signal;
transmitting an acknowledgement signal representative of the respective acoustic received signal strength by each of the acoustic sensor nodes to immediately adjacent acoustic sensor nodes if the respective acoustic received signal strength is greater than the threshold signal strength value;
comparing the acknowledgement signals transmitted by the immediately adjacent acoustic sensor nodes against the acoustic received signal strength measured by the acoustic sensor node, and recording respective times of reception of each of the acknowledgement signals in the non-transitory, computer readable memory associated with the acoustic sensor node, the comparing being done by each of the acoustic sensor nodes;
determining an acoustic sensor node closest to the leak to be the acoustic sensor node with the greatest measured acoustic received signal strength;
determining an acoustic sensor node second closest to the leak to be the immediately adjacent acoustic sensor node having the second greatest measured acoustic received signal strength;
calculating a distance, L, from the leak to the acoustic sensor node closest to the leak as:
L=1/2[D−V·(TACK2t1)],
where D represents a distance between adjacent pairs of the acoustic sensor nodes, V represents a speed of acoustic signal transmission in the fluid, TACK2 is the recorded time of reception at the acknowledgement signal of the acoustic sensor node second closest to the leak, and t1 represents the recorded time of reception of the acoustic signal received by the acoustic sensor node closest to the leak; and
transmitting an alert signal representative of a position of the leak in the wall of the pipeline.
